(19) United States
(12) Patent Application Publication
(10) Pub. No.: US 2018/0361439 A1
(43) Pub. Date: Dec. 20, 2018

(54) Local vacuum method for advancing a pipeline remediation pig

(71) Applicant: Benton Frederick Baugh, Houston, TX (US)

(72) Inventor: Benton Frederick Baugh, Houston, TX (US)

(21) Appl. No.: 15/625,171

(22) Filed: Jun. 16, 2017

(51) Int. Cl. B08B 9/049; B08B 9/055; B08B 9/053

(52) U.S. Cl. CPC B08B 9/049; B08B 9/0551; F16L 55/1283; B08B 9/0535; B08B 9/055; B08B 9/0553

(57) ABSTRACT

A method assisting the movement of a tool within a pipeline to a distal direction with respect to the point of entry to provide remediation within the pipeline by pumping a volume of fluid into the front of tool through a motor and having the motor drive a pump which removes more volume from the front of the pig than was pumped into it, thereby causing a relative vacuum in front of the tool.

### TECHNICAL FIELD

This invention relates to the method of providing a relative vacuum locally in front of a pipeline remediation pig to advance the pig further into the pipeline during a cleaning process.

### BACKGROUND OF THE INVENTION

Typically, when a blockage of a pipeline is to be remediated, it requires that a flow path be established to and from the area of the blockage. The pipeline itself will form one of the flow paths. The other must be in the form of some sort of tubular member placed within the pipeline. This tubular member is most often a steel string of coiled tubing, or thin walled pipe delivered to the entrance point of the pipeline on a reel.

As the coiled tubing will only go a short distance into the pipeline without forming a spiral column buckling preventing further progress, a cleaning pig with sealing cups to seal against the bore of the pipeline is attached to the end of the coiled tubing to pull the pipeline into the pipeline. The area inside the bore of the pipeline and outside the coiled tubing makes one of these flow paths and pumping into this area will drive the pig and therefore drag the coiled tubing out to the site of the blockage. While the cleaning pig is travelling out the pipeline, the fluids in front of the pig are forced back up the bore of the coiled tubing.

During the trip out and/or when the cleaning pig has arrived at the site of the blockage, drag can be induced on the coiled tubing at the entrance point to cause a pressure buildup across the sealing cups of the cleaning pig. At that point, the pressure differential across the sealing cups and therefore any jetting nozzles can be utilized to help remediate the blockage and/or buildup on the walls. The process uses the large annular area to flow out to the cleaning pig.

If you want to jet at 50 gallons per minute through a pipeline with a 5.761-inch internal bore using 1.25″ internal bore coiled tubing for 5000 feet, the flow loss out the annulus is less than 1 p.s.i., however the flow loss returning in the coiled tubing is about 1862 p.s.i. If you want to have 500 p.s.i. jetting pressure across the jet nozzles on the cleaning pig you must pump approximately 2362 p.s.i. The tension induced on the coiled tubing is 61,592 lbs. The resulting stress in the coiled tubing is 114,067 p.s.i., which will destroy the coiled tubing. The 2362 p.s.i. in the annulus will in some cases exceed the working pressure of the pipeline. To clean a 10,000-ft. pipeline, the pressures become even higher. The operation must make compromises on flow rates and pressures which are practical to use in the situation.

The combinations of relatively high pressures required to get effective jet cleaning, low working pressure of some pipelines, and the resulting high tensile forces on the coiled tubing can make this a difficult combination to negotiate. A method to achieve this jetting which does not over stress he coiled tubing or threaten to rupture some of the pipelines would be advantageous.

These restrictions have plagued the remediation industry for the past several decades and has caused substantial limitations to the cleaning which can be accomplished.

### BRIEF SUMMARY OF THE INVENTION

The objective of this invention is to provide a controlled forward movement to a cleaning pig which is pulling a coiled tubing string in a pipeline.

A second objective of this method is to provide a method of flowing to a cleaning pig through a coiled tubing string and take the annulus flow back up the annular outside of the coiled tubing string during a cleaning operation.

A third objective of this method is to allow the cleaning pig to be moved out to the cleaning location by pumping into the annular area between the internal bore of the coiled tubing and the outside diameter of the coiled tubing.

Another objective of this method is to use power fluid flow down the coiled tubing string to power a pump/motor combination to cause a relative vacuum in the front of the cleaning pig to urge the pig forward.

### BRIEF DESCRIPTION OF THE DRAWINGS

FIG. 1 is a view of an offshore platform and pipeline showing a hydrate or wax blockage formed in the pipeline and a cleaning operation in progress.

FIG. 2 shows a cleaning pig being moved out to a cleaning location.

FIG. 3 shows flow has been stopped and the diverter section of the selector valve has shifted.

FIG. 4 shows pumping out to the cleaning pig through the coiled tubing or hose during the actual cleaning process.

FIG. 5 shows flow has been stopped and the diverter section of the selector valve has shifted.

FIG. 6 shows pumping out to the cleaning pig through the coiled tubing or hose to return the cleaning pig to the point of entry.

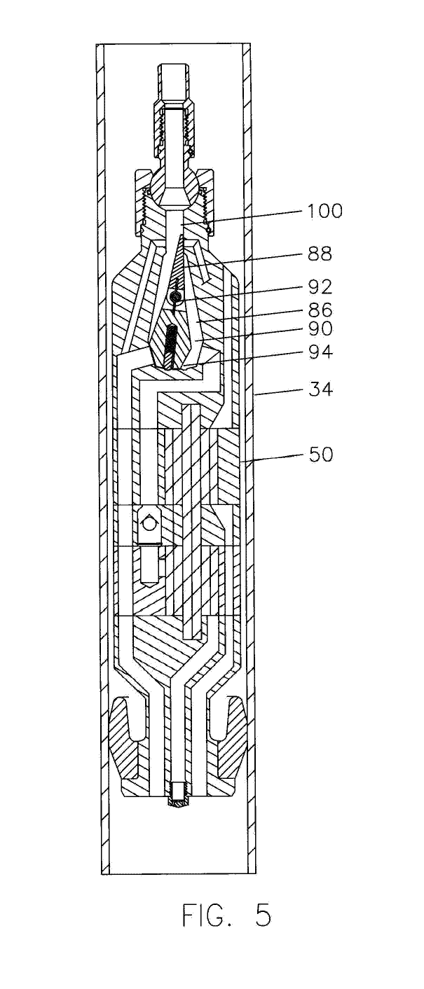

FIG. 5 shows flow has been stopped and the diverter section of the selector valve has shifted again.

### DETAILED DESCRIPTION OF THE INVENTION

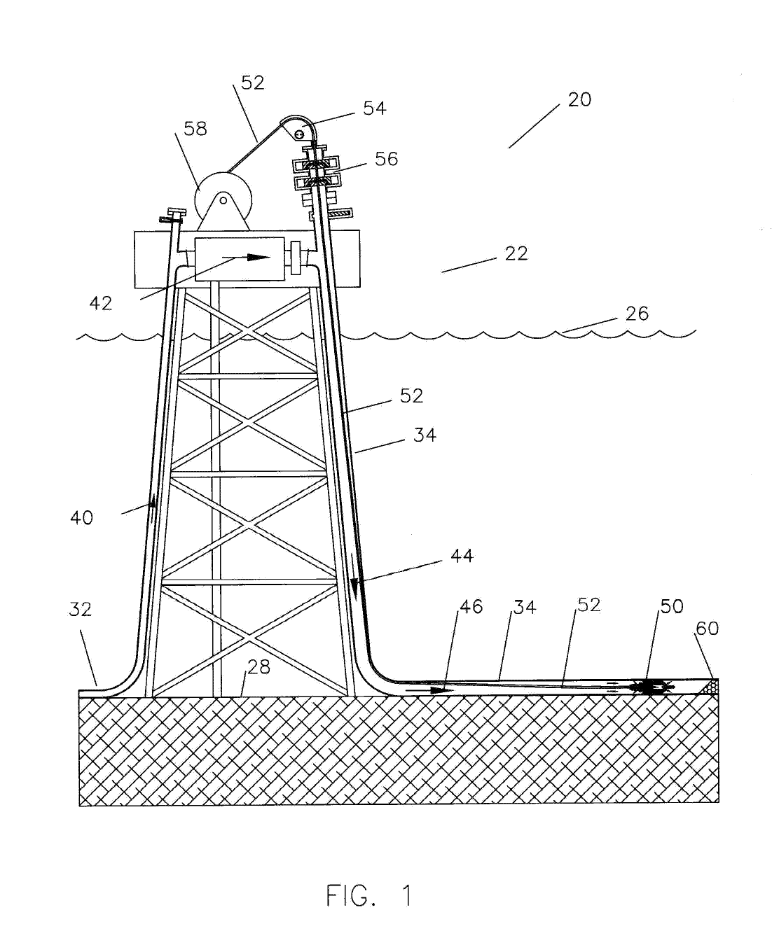

Referring now to FIG. 1, a view of a system 20 utilizing the present invention is shown with platform 22, the ocean surface 2 , the seafloor 28, an incoming pipeline 32 which brings hydrocarbons to first platform 22 and an export pipeline 34 which takes the hydrocarbons to a delivery point which is likely the shore.

Arrows 40-46 indicate the flow and direction of the flow within the pipelines. Cleaning pig 50 moves within the flow and is restrained from moving freely in the flow by coiled tubing or hose 52. Coiled tubing or hose 52 goes back to injector head 54 with blowout preventers 56 and storage reel 58. Blockage 60 is the target of the remediation and may be hydrates waxes or paraffins depending on the nature of the normal flow in the pipeline.

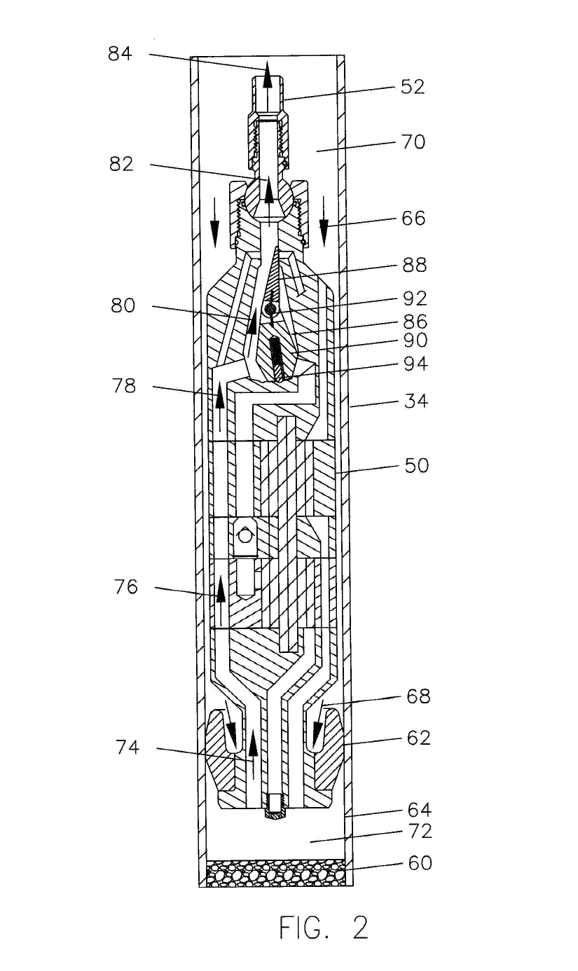

Referring now to FIG. 2, cleaning pig 50 is shown moving in pipeline 34 towards blockage 60 with sealing cup 62 sealing against the internal bore 64 of pipeline 3. Arrows 66 and 68 illustrate the flow coming in the annular area 70 between the internal bore 64 and the coiled tubing or hose 52 to provide a motive force to cleaning pig 50. Fluids in area 72 in front of cleaning pig 50 pass through cleaning pig 50 as illustrated by arrows 74-84. As the flow moves past selector valve 86, as particularly shown by arrow 80, the diverter section 88 and actuator section 90 are moved to the position as shown, bending spring 92 which attempts to keep diverter section 88 and actuator section 90 aligned. Detent mechanism 94 tends to retain the actuator section 90 in place when the flow is stopped, tending to cause diverter section 88 to move into alignment with actuator section 90. This allows the cleaning pig to move along the pipeline to the cleaning location.

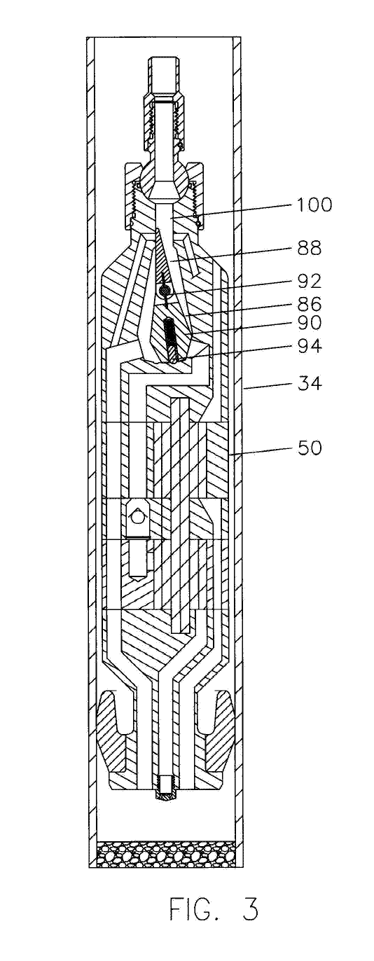

Referring now to FIG. 3, flow has been stopped in the line and actuator 90 is retained in place by detent mechanism 94 and spring 92 moves diverter section 88 into alignment with actuator section 90 or to the other side of flow passage 100.

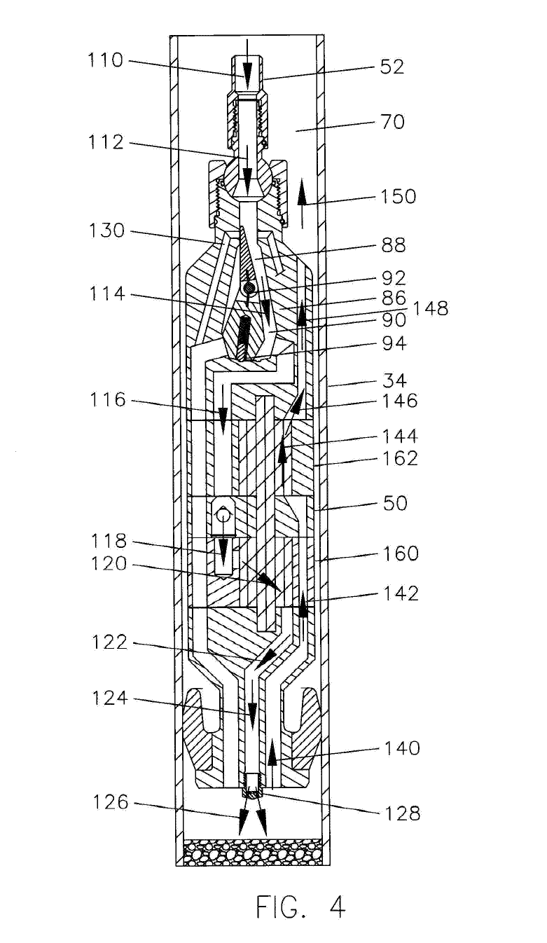

Referring now to FIG. 4, flow is input to the coiled tubing or hose and flows through cleaning pig 50 as indicated by arrows 110-126, ending by being accelerated through jet nozzle 128. As the flow passed the selector valve 86, it pushed actuator section 90 to the opposite position. Diverter section 88 remains in place, assisted by the lower pressure within port 130. Flow return though cleaning pig 50 to the annular area 70 as shown by return flow arrows 140-150. Flow arrow 120 is shown going through positive displacement motor 160 and return flow arrow 144 is shown going though positive displacement pump 162. Positive displacement motor 160 powers positive displacement pump 162. The motor and pump will likely be of a gear style, which are well known in the art. Positive displacement pump 162 has slightly higher net displacement or pump flow capacity than positive displacement motor 160. This means that a little more fluid will be drawn out of area 72 by positive displacement pump 162 than enters from motor 160, tending to draw a relative vacuum in this area. This relative vacuum provides the force to move the cleaning pig 50 forward in spite of setting forces.

Referring now to FIG. 5, flow has been stopped in the line and actuator 90 is retained in place by detent mechanism 94 and spring 92 moves diverter section 88 into alignment with actuator section 90 or to the other side of flow passage 100.

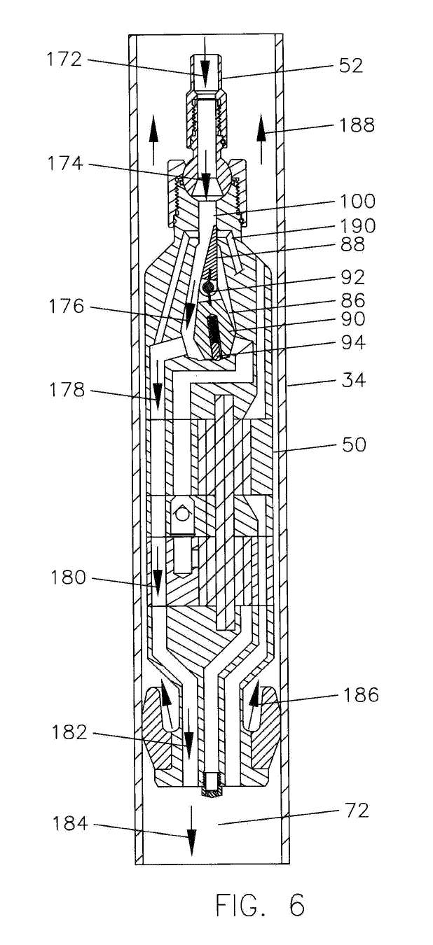

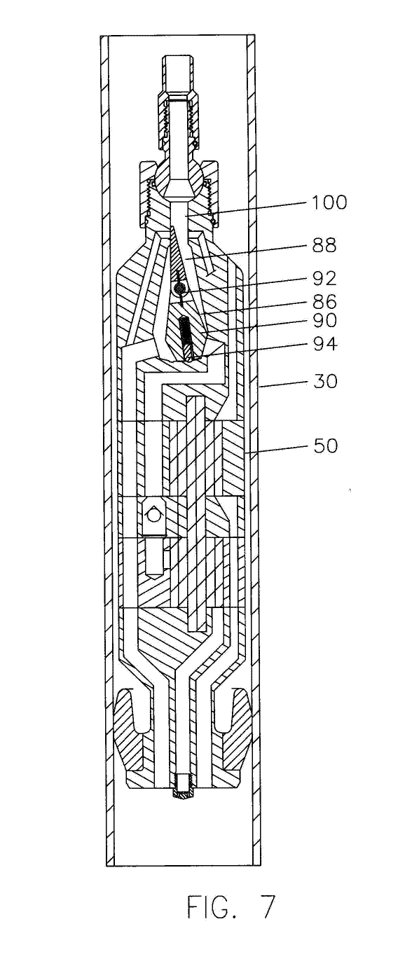

Referring now to FIG. 6, flow in input to coiled tubing or hose 52 and follows the path as indicated by flow arrows 172-184 to the area 72. This flow will tend to push the cleaning pig 50 back towards the entrance point, pushing annular flow as shown by arrows 186-188 with it. Actuator section 90 remains was shifted and diverter section 88 remains in place, assisted by the lower pressure within port 190.

Referring now to FIG. 7, when flow is stopped again, the actuator section 88 will return to alignment with actuator section 90, ready to start the process again.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

That which is claimed is:

1. A method moving a tool within a pipeline in a distal direction with respect to the point of entry, comprising
providing a tool comprising a sealing cup to engage the bore of said pipeline, a tool pump, and a tool motor to drive said pump,
said tool having a proximate end and a distal end,
attaching a tubular member to said proximate end of said tool and inserting said tool into said point of entry into said pipeline,
pumping into the annular area between said bore of said pipeline and the outer diameter of said tubular member to move said tool to a distal location within said pipeline,
pumping a first volume into said tubular member to pass through said tool motor and then into the area of the pipeline on said distal end of said tool,
using said tool pump to pump a second volume of fluid from the area of said pipeline on said distal end of said tool into said annular area,
said second volume being greater than said first volume,
the resulting reduced volume of fluid or gas in said pipeline on said distal end of said tool causing a relative vacuum on said distal end of said tool,
said relative vacuum urging said tool to a more distal location.

2. The method of claim 1 further comprising providing remediation devices on said distal end of said tool.

3. The method of claim 2 further comprising said remediation devices are one or more jet nozzles.

4. The method of claim 1 further comprising said urging of said tool to a more distant location is urging said tool towards an area of said pipeline which needs to be remediated.

5. The method of claim 4 further comprising said area of said pipeline which needs to be remediated is a blockage.

6. The method of claim 5 further comprising said blockage comprises hydrates.

7. the method of claim 6 further comprising said blockage comprises waxes or paraffins.

8. The method of claim 1 further comprising said tubular member is a steel pipe.

9. The method of claim 1 further comprising said tubular member is a hose.

10. The method of claim 1 further comprising said motor is a positive displacement motor.

11. the method of claim 10 further comprising said motor is a vane style motor.

12. The method of claim 10 further comprising said motor is a gear style pump.

13. The method of claim 1 further comprising said pump is a positive displacement plump.

14. The method of claim 14 further comprising said pump is a vane style pump.

15. The method of claim 14 further comprising said pump is a gear style pump.
